(19) United States
(12) Patent Application Publication
(10) Pub. No.: US 2026/0148227 A1
(43) Pub. Date: May 28, 2026

(54) INFORMATION PROCESSING APPARATUS THAT NOTIFIES OCCURRENCE OF PAYMENT TROUBLE, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KENTARO TAKAHASHI, Tokyo (JP)

(21) Appl. No.: 19/386,842

(22) Filed: Nov. 12, 2025

(30) Foreign Application Priority Data
Nov. 27, 2024 (JP) 2024-206281

(51) Int. Cl. G06Q 20/40; G06Q 30/0645

(52) U.S. Cl. CPC G06Q 20/40; G06Q 30/0645

(57) ABSTRACT

An information processing apparatus that can be used at a flat rate during a contract period. A communication section performs communication with a contract management apparatus that manages a contract state of the information processing apparatus. Control to restrict functions which are available in the information processing apparatus is performed based on control information received from the management apparatus. In a case where it is determined, based on the control information, that a payment trouble has occurred in payment for the contract of the information processing apparatus, control to notify occurrence of the payment trouble is performed.

### BACKGROUND

### Field of the Technology

The present disclosure relates to an information processing apparatus that notifies occurrence of a payment trouble, a method of controlling the information processing apparatus, and a storage medium.

### Description of the Related Art

A flat rate service for renting an apparatus, such as an image processing apparatus, at a flat rate during a contract period has become widespread. In this flat rate service, it is necessary to restrict functions of a rented apparatus based on a contract state. As a related art, there has been proposed a technique in Japanese Laid-Open Patent Publication (Kokai) No. 2021-70161. In Japanese Laid-Open Patent Publication (Kokai) No. 2021-70161, an image processing apparatus inquires a server that manages the contract state of the image processing apparatus about the contract state and controls whether or not to restrict the functions of the image processing apparatus.

In such a flat rate service, for example, in a case where a payment trouble has occurred which is caused by a credit card payment company or a financial institution, even if there is no problem in a procedure on a user’s side, the functions of the image processing apparatus are restricted. In this case, a service operating company generally transmits a mail notifying this fact to e.g. a personal computer (PC) of the user, but the user often fails to notice this mail and is confused by the situation that the image processing apparatus suddenly becomes unavailable.

### SUMMARY

The present disclosure is directed to providing a mechanism that enables a user to recognize occurrence of a payment trouble.

In a first aspect of the present disclosure, there is provided an information processing apparatus that can be used at a flat rate during a contract period, including a communication unit configured to perform communication with a management apparatus that manages a contract state of the information processing apparatus, and a control unit configured to perform control to restrict functions which are available in the information processing apparatus, based on control information received from the management apparatus, wherein in a case where it is determined, based on the control information, that a payment trouble has occurred in payment for the contract of the information processing apparatus, the control unit performs control to notify occurrence of the payment trouble.

In a second aspect of the present disclosure, there is provided a method of controlling an information processing apparatus that can be used at a flat rate during a contract period, including performing communication with a management apparatus that manages a contract state of the information processing apparatus, and performing control to restrict functions which are available in the information processing apparatus, based on control information received from the management apparatus, and wherein in a case where it is determined, based on the control information, that a payment trouble has occurred in payment for the contract of the information processing apparatus, the control includes control to notify occurrence of the payment trouble.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram schematically showing a hardware configuration of an image processing apparatus as an information processing apparatus according to the present embodiment.

FIG. 2 is a block diagram showing a configuration of functions of the image processing apparatus shown in FIG. 1.

FIG. 3 is a block diagram schematically showing a configuration of a contract management apparatus that manages a contract state of the image processing apparatus shown in FIG. 1.

FIG. 4 is a diagram showing an example of contract information managed by a contract management section appearing in FIG. 3.

FIG. 5 is a flowchart of a contract state confirmation process performed by the contract management apparatus shown in FIG. 3.

FIG. 6 is a flowchart of a reception control process performed by the image processing apparatus shown in FIG. 1.

FIG. 7 is a flowchart of a notification process in a step in FIG. 6.

FIG. 8 is a diagram showing an example of a dialog displayed on an operation panel appearing in FIG. 1.

FIG. 9 is a flowchart of a printing control process performed by the image processing apparatus shown in FIG. 1.

FIG. 10 is a flowchart of a variation of the contract state confirmation process performed by the contract management apparatus shown in FIG. 3.

FIG. 11 is a flowchart of a variation of the notification process in the step in FIG. 6.

FIG. 12 is a diagram showing an example of a print product output by a printer appearing in FIG. 1.

FIG. 13 is a flowchart of a variation of the printing control process performed by the image processing apparatus shown in FIG. 1.

### DESCRIPTION OF THE EMBODIMENTS

The present disclosure will now be described in detail below with reference to the accompanying drawings showing embodiments thereof.

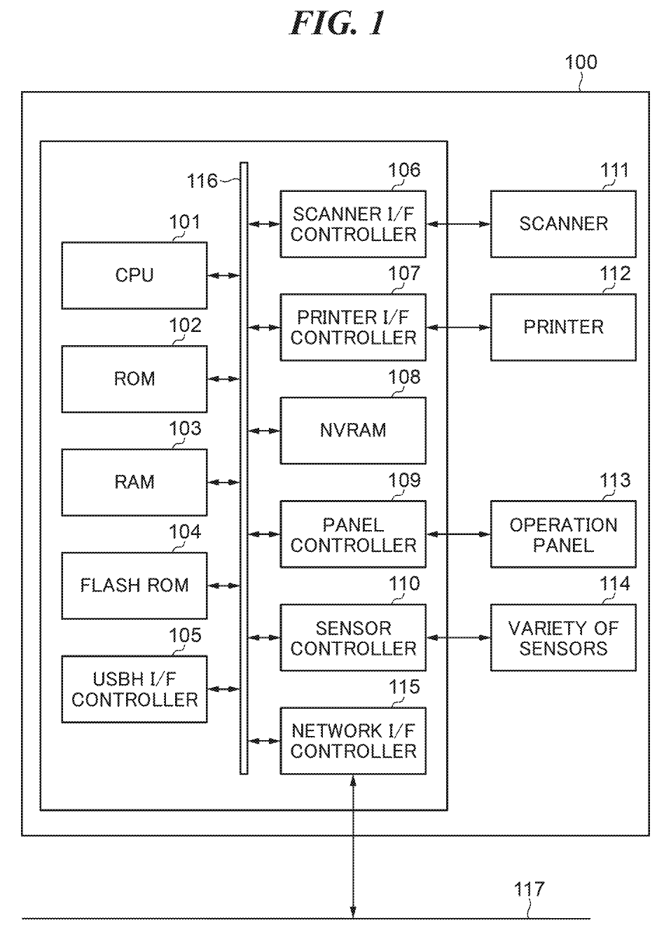

FIG. 1 is a block diagram schematically showing a hardware configuration of an image processing apparatus 100 as an information processing apparatus according to the present embodiment.

Referring to FIG. 1, the image processing apparatus 100 includes a central processing unit (CPU) 101, a read only memory (ROM) 102, a random access memory (RAM) 103, a flash ROM 104, a Universal Serial Bus Host (USBH) interface (I/F) controller 105, a scanner I/F controller 106, a printer I/F controller 107, a non-volatile (NV) RAM 108, a panel controller 109, a sensor controller 110, and a network I/F controller 115. These are connected to each other via a bus 116. Further, the image processing apparatus 100 includes a scanner 111, a printer 112, an operation panel 113, and a variety of sensors 114.

The CPU 101 executes software programs of the image processing apparatus 100 to control the overall operation of the image processing apparatus 100. The ROM 102 stores a boot program, fixed parameters, and so forth of the image processing apparatus 100. The RAM 103 is used e.g. for temporarily storing data when the CPU 101 controls the image processing apparatus 100. The flash ROM 104 stores installed applications and a variety of data, such as data of each application and print data.

The USBH I/F controller 105 is for controlling a USB host I/F and controls communication with a variety of USB devices. The scanner I/F controller 106 controls the scanner 111. The printer I/F controller 107 controls the printer 112. The NV RAM 108 stores a variety of settings of the image processing apparatus 100. The panel controller 109 controls the operation panel 113 to display a variety of information on the operation panel 113, and further acquires information on an operation performed by a user on the operation panel 113, from the operation panel 113. The sensor controller 110 controls the variety of sensors 114. The variety of sensors 114 include e.g. a human detection sensor for determining whether or not there is a person in front of the image processing apparatus 100.

The network I/F controller 115 controls transmission/reception of data to and from a local area network (LAN) network 117. The bus 116 is a system bus for transferring control signals output from the CPU 101 and data signals output from components connected to the bus 116.

Note that in the present embodiment, the CPU 101 can function as a variety of means by executing programs. Note that a control circuit, such as an application specific integrated circuit (ASIC), which operates in cooperation with the CPU 101, can function as these means. Further, these means can be realized by cooperation between the CPU 101 and control circuits for controlling the operations of the image processing apparatus 100. Further, the CPU 101 is not required to be single but can be provided in plurality. In this case, the plurality of CPUs 101 can execute processing operations in a distributed state. Further, the plurality of CPUs 101 can be disposed in a single computer or in a plurality of computers which are physically different from each other. Note that means realized by the CPU 101 executing a program can be realized by a dedicated circuit.

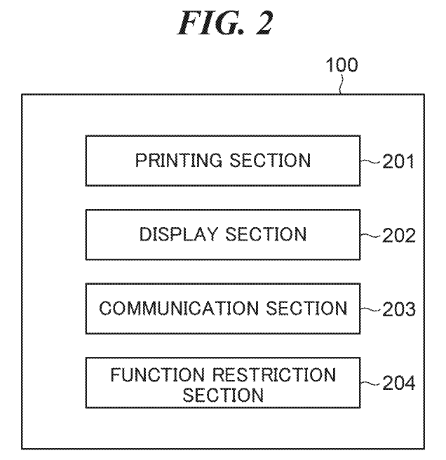

FIG. 2 is a block diagram showing a configuration of functions of the image processing apparatus 100 shown in FIG. 1. The image processing apparatus 100 is configured such that a user can use the image processing apparatus 100 during a contract period e.g. by submitting an application for a subscription contract, such as a contract of payment at a flat rate per month. The image processing apparatus 100 has, as its functions, a printing section 201, a display section 202, a communication section 203, and a function restriction section 204, as shown in FIG. 2. The printing section 201 is a function of executing printing by using the printer 112. The display section 202 is a function of displaying a variety of screens on the operation panel 113. The communication section 203 is a function of performing communication with an external apparatus via the network I/F controller 115. The function restriction section 204 is a function for restricting the functions of the printing section 201 based on control information, described hereinafter, which is received from a contract management apparatus 300.

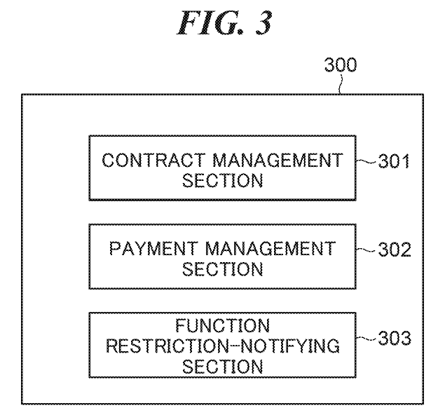

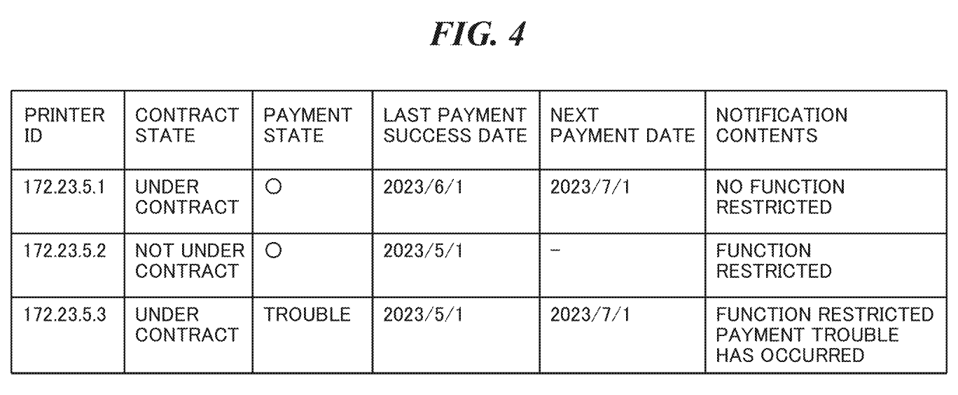

FIG. 3 is a block diagram schematically showing a configuration of the contract management apparatus 300 that manages a contract state of the image processing apparatus 100 shown in FIG. 1. Referring to FIG. 3, the contract management apparatus 300 includes a contract management section 301, a payment management section 302, and a function restriction-notifying section 303. The contract management section 301 manages contract information shown in FIG. 4, which indicates contents of a contract made by a user. The payment management section 302 manages a payment state. The function restriction-notifying section 303 transmits control information used for control to restrict functions which are available in an apparatus (such as the image processing apparatus 100) used by a user who has made the subscription contract.

FIG. 4 is a diagram showing an example of the contract information managed by the contract management section 301 appearing in FIG. 3. The contract information includes, for each printer ID which is unique information for identifying an apparatus used by a user who has made the subscription contract, a contract state, a payment state, a last payment success date, a next payment date, and contents of a notification indicating contents of the control information transmitted to the above-mentioned apparatus. The contract management apparatus 300 determines, based on this contract information, for example, whether or not to enable a user to use the functions of the image processing apparatus 100 which is the apparatus used by the user who has made the subscription contract. The contract management apparatus 300 transmits, based on a result of this determination, the control information which is used for the control to restrict the functions available in the image processing apparatus 100, to the image processing apparatus 100.

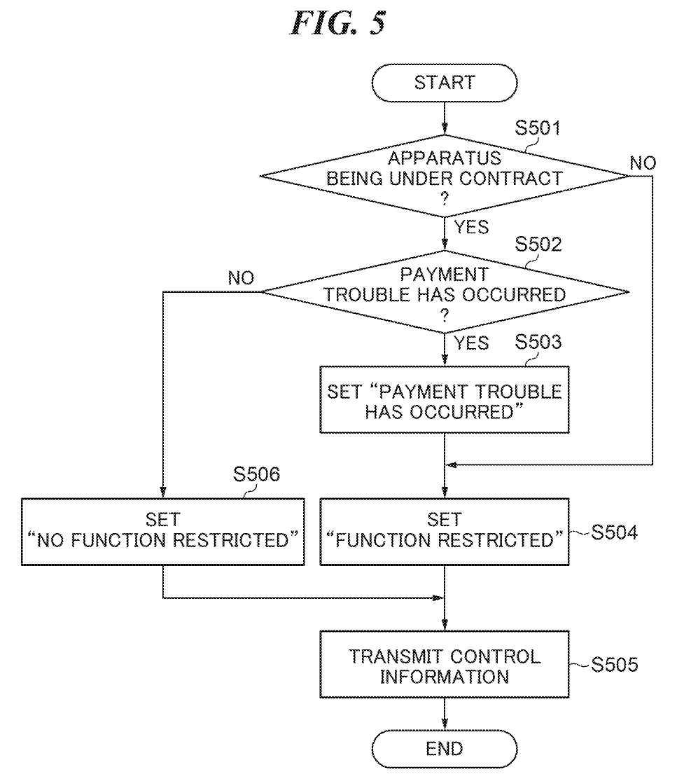

FIG. 5 is a flowchart of a contract state confirmation process performed by the contract management apparatus 300 shown in FIG. 3. The contract management apparatus 300 periodically executes the contract state confirmation process in FIG. 5 with respect to all apparatuses to be managed, including the image processing apparatus 100. Note that in the present embodiment, the contract state confirmation process is performed with respect to the image processing apparatus 100 as the apparatus to be managed by the contract management apparatus 300, by way of example.

Referring to FIG. 5, first, the contract management apparatus 300 determines, based on the contract information, whether or not the image processing apparatus 100 is under contract (S501). If it is determined in the step S501 that the image processing apparatus 100 is not under contract, the present process proceeds to a step S504, described hereinafter. If it is determined in the step S501 that the image processing apparatus 100 is under contract, the present process proceeds to a step S502.

In the step S502, the contract management apparatus 300 determines whether or not a payment trouble has occurred. In the step S502, the determination of whether or not a payment trouble has occurred is performed by using, for example, an application programming interface (API) provided by the payment service company.

If it is determined in the step S502 that a payment trouble has occurred, the present process proceeds to a step S503. In the step S503, the contract management apparatus 300 sets “payment trouble has occurred” indicating that a payment trouble has occurred, in the control information. Then, the contract management apparatus 300 sets “function restricted” indicating that the functions available in the image processing apparatus 100 are restricted, in the control information (S504). Then, the contract management apparatus 300 transmits this control information to the image processing apparatus 100 (S505), followed by terminating the present process.

If it is determined in the step S502 that a payment trouble has not occurred, the present process proceeds to a step S506. In the step S506, the contract management apparatus 300 sets “no function restricted” indicating that the functions available in the image processing apparatus 100 are not restricted, in the control information (S506). After that, the present process proceeds to the step S505, and this information is transmitted to the image processing apparatus 100, followed by terminating the present process.

Note that although in the above-described embodiment, the contract state confirmation process is periodically performed, this is not limitative, but, for example, the contract state confirmation process can be performed when the contract management apparatus 300 receives an inquiry from the image processing apparatus 100.

Next, a reception control process performed by the image processing apparatus 100, for receiving the control information transmitted from the contract management apparatus 300, will be described.

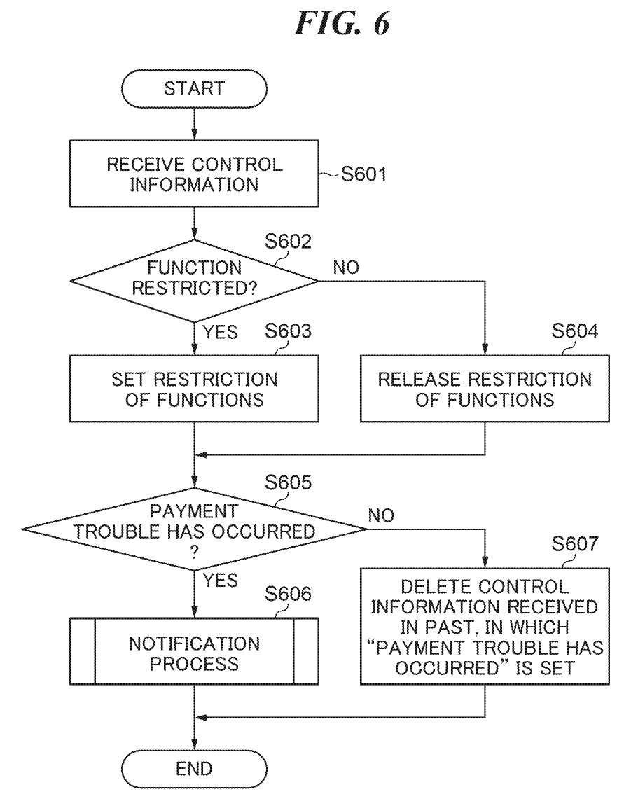

FIG. 6 is a flowchart of the reception control process performed by the image processing apparatus 100 shown in FIG. 1. The reception control process in FIG. 6 is realized by the CPU 101 of the image processing apparatus 100, executing a program stored e.g. in the ROM 102.

Referring to FIG. 6, first, the CPU 101 receives the control information transmitted from the contract management apparatus 300 in the above-described step S505 (S601). Then, the CPU 101 determines whether or not “function restricted” is set in the received control information (S602). If it is determined that “function restricted” is set in the control information, the present process proceeds to a step S603. If it is determined that “function restricted” is not set in the control information, the present process proceeds to a step S604.

In the step S603, the CPU 101 sets restriction of the functions to the image processing apparatus 100 (S603). With this, in the image processing apparatus 100, the function of the print section 201 is restricted, for example, and printing becomes unavailable. Thereafter, the present process proceeds to a step S605, described hereinafter.

In the step S604, the CPU 101 releases function restriction in the image processing apparatus 100. With this, in the image processing apparatus 100, for example, all functions associated with the contents of the contract become available. Then, the CPU 101 determines whether or not “payment trouble has occurred” is set in the received control information (S605).

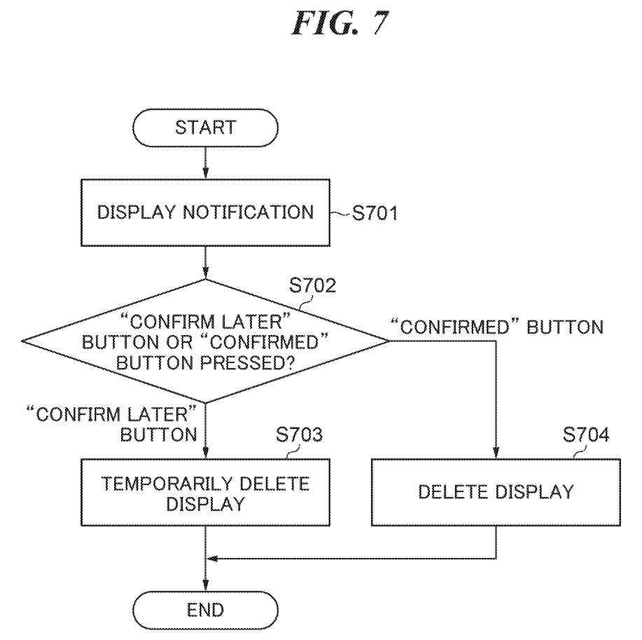

If it is determined in the step S605 that “payment trouble has occurred” is set in the control information, the present process proceeds to a step S606. In the step S606, the CPU 101 performs a notification process, described hereinafter with reference to FIG. 7, and notifies the user of occurrence of a payment trouble. Note that the control information in which “payment trouble has occurred” is set can be held in the RAM 103 or the like. After that, the present process is terminated.

If it is determined in the step S605 that “payment trouble has occurred” is not set in the control information, the present process proceeds to a step S607. In the step S607, the CPU 101 deletes the control information received and held in the past, in which “payment trouble has occurred” is set. After that, the present process is terminated.

FIG. 7 is a flowchart of the notification process in the step S606 in FIG. 6.

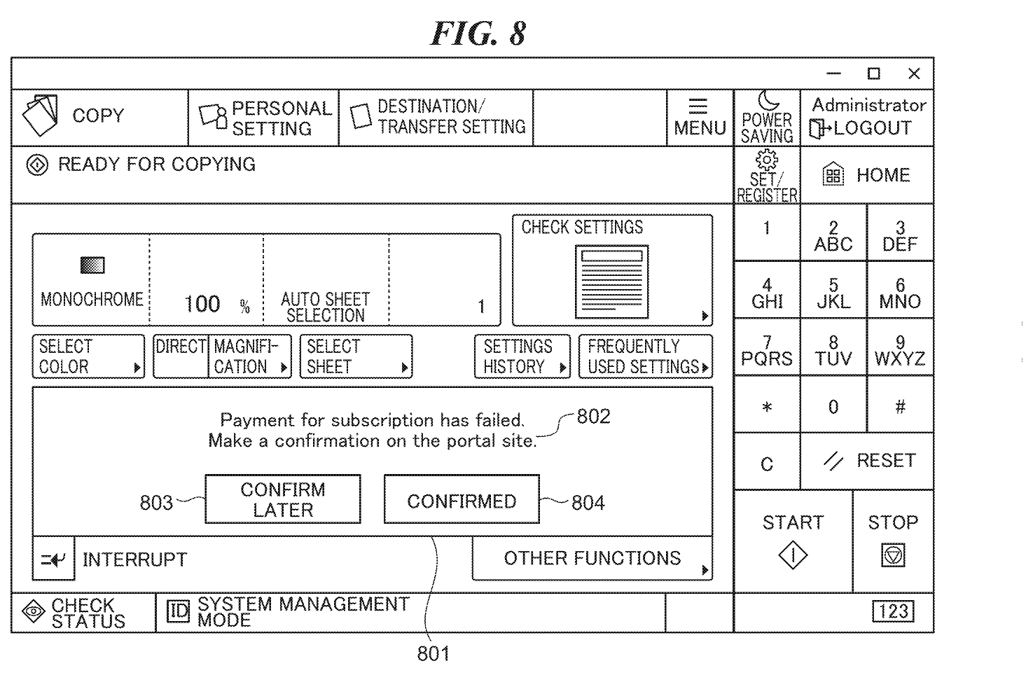

Referring to FIG. 7, the CPU 101 notifies the user of occurrence of the payment trouble (S701). Specifically, the CPU 101 displays a dialog 801 shown in FIG. 8 on the operation panel 113 as the notification notifying occurrence of the payment trouble. The dialog 801 includes a message 802 indicating that the payment trouble has occurred, a “confirm later” button 803, and a “confirmed” button 804. When the user selects the “confirm later” button 803 or the “confirmed” button 804 on the dialog 801, the present process proceeds to a step S702.

In the step S702, the CPU 101 determines which of the “confirm later” button 803 and the “confirmed” button 804 has been pressed by the user.

If it is determined in the step S702 that the “confirm later” button 803 has been pressed, the present process proceeds to a step S703. In the step S703, the CPU 101 temporarily deletes the display of the dialog 801. With this, the user can postpone coping with the notification indicating occurrence of the payment trouble and perform an operation of the image processing apparatus 100. In this case, in the image processing apparatus 100, after a certain time period elapses, the dialog 801 is displayed on the operation panel 113 again. When the step S703 is completed, the present process is terminated.

If it is determined in the step S702 that the “confirmed” button 804 has been pressed, the present process proceeds to a step 704. In the step S704, the CPU 101 deletes the display of the dialog 801. After that, the present process is terminated. Note that even if the user erroneously presses the “confirmed” button 804, unless the payment trouble is solved, the control information in which “payment trouble has occurred” is set is transmitted again from the contract management apparatus 300 to the image processing apparatus 100. Therefore, when this control information is received, the dialog 801 is displayed on the operation panel 113 again.

Next, a process performed when the image processing apparatus 100 receives a print instruction from the user will be described.

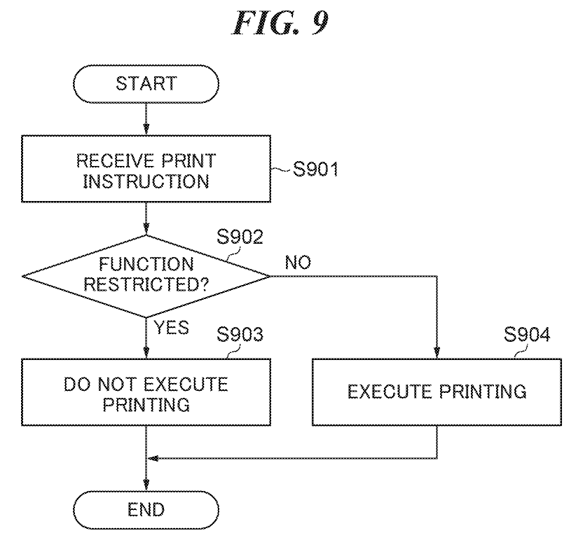

FIG. 9 is a flowchart of a printing control process performed by the image processing apparatus 100 shown in FIG. 1. The printing control process in FIG. 9 is realized by the CPU 101 of the image processing apparatus 100, executing a program stored e.g. in the ROM 102. Note that in the present embodiment, it is assumed that the above-described reception control process has been executed to set or release function restriction in the image processing apparatus 100 before execution of the printing control process in FIG. 9.

Referring to FIG. 9, the CPU 101 receives a print instruction provided by the user (S901). Then, the CPU 101 determines whether or not function restriction has been set (S902).

If it is determined in the step S902 that function restriction has been set, the CPU 101 does not execute printing according to the received print instruction (S903). Note that at this time, for example, a screen including a message to the effect that the contract has been expired can be displayed on the operation panel 113. After that, the present process is terminated.

If it is determined in the step S902 that function restriction has not been set, the CPU 101 executes printing according to the received print instruction (S904). After that, the present process is terminated.

According to the above-described embodiment, in a case where it is determined, based on the control information received from the contract management apparatus 300, that a payment trouble has occurred, the control is performed to notify the user of occurrence of the payment trouble. This enables the user to recognize occurrence of the payment trouble.

Further, in the above-described embodiment, the control information includes “payment trouble has occurred” indicating that a payment trouble has occurred and the information (“function restricted” or “no function restricted”) indicating whether or not to restrict the functions available in the image processing apparatus 100. With this, the image processing apparatus 100 can easily determine, based on the control information received from the contract management apparatus 300, whether or not a payment trouble has occurred and whether or not to restrict the functions available in the image processing apparatus 100, with the minimum resources.

Further, in the above-described embodiment, in a case where it is determined, based on the control information received from the contract management apparatus 300, that a payment trouble has occurred, the dialog 801 notifying occurrence of the payment trouble is displayed on the operation panel 113. This makes it possible for the user who provides a print instruction to the image processing apparatus 100 by operating the operation panel 113 to recognize occurrence of the payment trouble.

Note that in the above-described embodiment, when occurrence of a payment trouble is detected by the contract management apparatus 300, the image processing apparatus 100 performs the notification for notifying occurrence of the payment trouble, and at the same time, the restriction of functions of the image processing apparatus 100. However, after the notification for notifying occurrence of the payment trouble is performed, it takes some time until the user solves the payment trouble, so that the user is unable to use the image processing apparatus 100 during this time period, which is inconvenient for the user. To prevent this inconvenient state, it is preferable not to restrict the functions of the image processing apparatus 100 during a predetermined time period after occurrence of a payment trouble.

To cope with this, in a first variation of the present embodiment, control is performed so as not to restrict the functions of the image processing apparatus 100 until a predetermined time period elapses after occurrence of a payment trouble. Note that in this configuration, part of the details of the above-described contract state confirmation process in FIG. 5 is different. The following description will be given of the contract state confirmation process in this configuration.

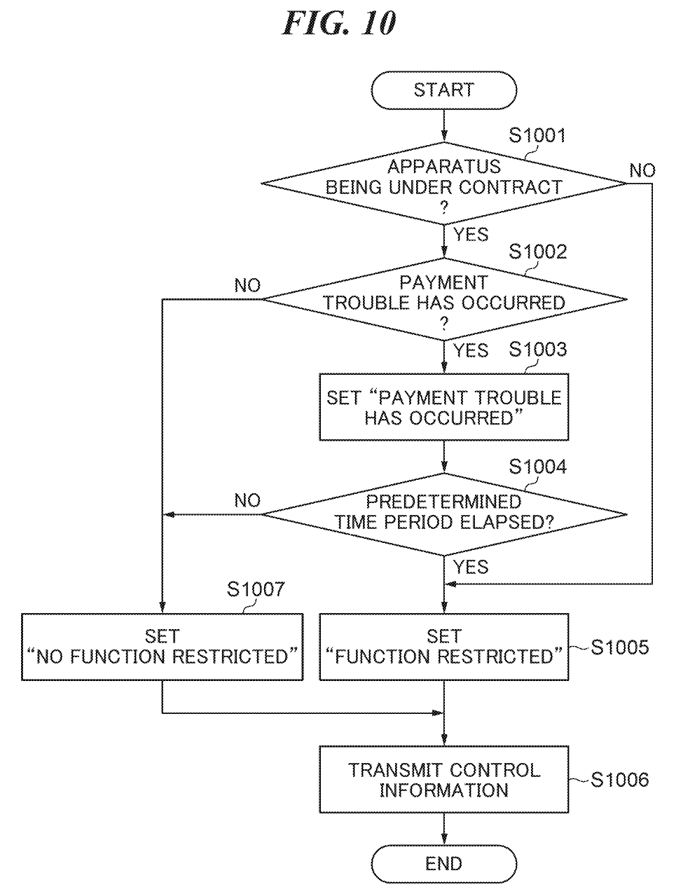

FIG. 10 is a flowchart of a first variation of the contract state confirmation process performed by the contract management apparatus 300 shown in FIG. 3. Note that the contract state confirmation process in FIG. 10 is a process similar to the above-described contract state confirmation process in FIG. 5, and the following description will be given mainly of different points from the contract state confirmation process in FIG. 5. The contract management apparatus 300 periodically executes the contract state confirmation process in FIG. 10 with respect to all apparatuses to be managed, including the image processing apparatus 100. Note that in the present embodiment, the contract state confirmation process is performed with respect to the image processing apparatus 100 as the apparatus to be managed by the contract management apparatus 300 , by way of example.

Referring to FIG. 10, first, similarly to the step S501, the contract management apparatus 300 determines, based on the contract information, whether or not the image processing apparatus 100 is under contract (S1001). If it is determined in the step S1001 that the image processing apparatus 100 is not under contract, the present process proceeds to a step S1005, described hereinafter. If it is determined in the step S1001 that the image processing apparatus 100 is under contract, the present process proceeds to a step S1002.

In the step S1002, similarly to the step S502, the contract management apparatus 300 determines whether or not a payment trouble has occurred. Note that the determination method in the step S1002 is the same as in the step S502. If it is determined that a payment trouble has not occurred, the present process proceeds to a step S1007, described hereinafter. If it is determined that a payment trouble has occurred, the present process proceeds to a step S1003.

In the step S1003, similarly to the step S503, the contract management apparatus 300 sets “payment trouble has occurred” indicating that a payment trouble has occurred in the control information.

Then, the contract management apparatus 300 determines, based on the contract information, whether or not a predetermined time period has elapsed from the time of occurrence of the payment trouble (S1004). The predetermined time period is e.g. a time period of several hours to several days. If it is determined that the predetermined time period has elapsed from the time of occurrence of the payment trouble, the present process proceeds to the step S1005. If it is determined that the predetermined time period has not elapsed from the time of occurrence of the payment trouble, the present process proceeds to the step S1007.

In the step S1005, similarly to the above-described step S504, the contract management apparatus 300 sets “function restricted” in the control information. Then, similarly to the step S505, the contract management apparatus 300 transmits this control information to the image processing apparatus 100 (S1006), followed by terminating the present process.

In the step S1007, similarly to the above-described step S506, the contract management apparatus 300 sets “no function restricted” in the control information. After that, the present process proceeds to the step S1006, and this information is transmitted to the image processing apparatus 100, followed by terminating the present process.

In the above-described embodiment, the control information transmitted from the contract management apparatus 300 when it is determined by the contract management apparatus 300 that the predetermined time period has not elapsed from the time of occurrence of the payment trouble includes “payment trouble has occurred” and “no function restricted”. That is, the functions of the image processing apparatus 100 are not restricted until the predetermined time period elapses from the time of occurrence of the payment trouble. With this, it is possible to reduce the inconvenience for the user more than the configuration that the image processing apparatus 100 immediately becomes unavailable in accordance with occurrence of a payment trouble.

Note that although in the above-described embodiment, the contract state confirmation process in FIG. 10 is periodically performed, this is not limitative, but for example, the contract state confirmation process in FIG. 10 can be performed when the contract management apparatus 300 receives an inquiry from the image processing apparatus 100.

Further, although in the above-described embodiment, as the notification for notifying occurrence of a payment trouble, the dialog 801 is displayed on the operation panel 113. However, in a compact model of the image processing apparatus 100, the screen size of the operation panel 113 is small, so that there is a problem that the user is difficult to notice the notification, or that the notification cannot be fully displayed. Further, in a case where the user provides a print instruction e.g. from a PC to the image processing apparatus 100, the user does not view the operation panel 113 of the image processing apparatus 100, and hence the user sometimes fails to notice the dialog 801 displayed on the operation panel 113.

To solve these problems, in a second variation of the present embodiment, a notification for notifying occurrence of a payment trouble is printed. Note that in this configuration, part of the details of the above-described notification process in the step S606 of the reception control process in FIG. 6 is different. The following description will be given of the notification process in the step S606 in this configuration.

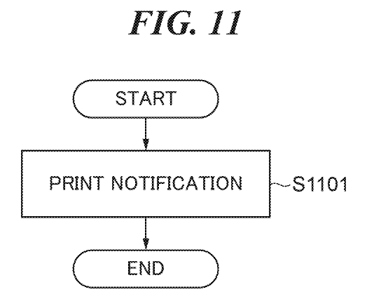

FIG. 11 is a flowchart of a second variation of the notification process in the step S606 in FIG. 6.

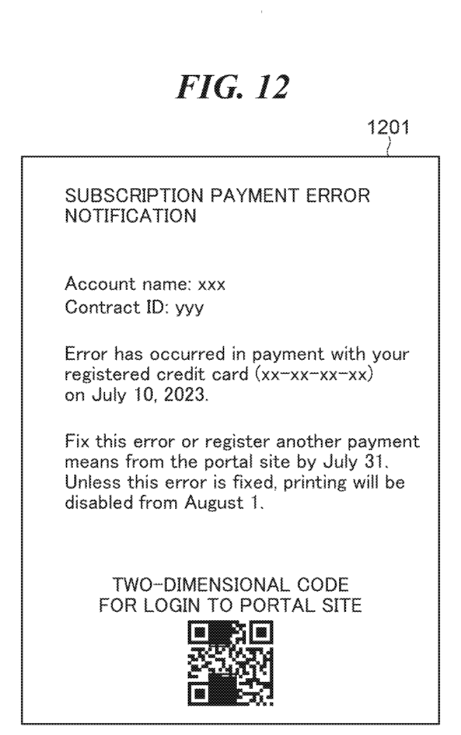

Referring to FIG. 11, the CPU 101 controls the printer 112 to print the notification for notifying occurrence of the payment trouble (S1101). With this, a print product 1201 shown in FIG. 12 is output. This print product 1201 includes a message notifying occurrence of the payment trouble, a method of solving the payment trouble, information indicating when printing will become unavailable in a case where the payment trouble is not solved, and so forth. After that, the present process is terminated.

In the above-described embodiment, in a case where it is determined, based on the control information received from the contract management apparatus 300, that a payment trouble has occurred, the print product 1201 notifying occurrence of the payment trouble is output. This makes it possible for the user to recognize occurrence of the payment trouble without using the operation panel 113.

Note that in the above-described embodiment, the notification for notifying occurrence of a payment trouble is printed. However, when the user is executing printing using a sheet more expensive than plain paper, such as glossy paper, if the notification for notifying occurrence of a payment trouble is printed by using the expensive sheet, an economic burden is increased for the user.

To prevent this, in a third variation of the present embodiment, whether or not to print the notification for notifying occurrence of a payment trouble is controlled based on a type of a printing sheet. Note that in this configuration, part of the details of the above-described printing control process in FIG. 9 is different. The following description will be given of the printing control process in this configuration.

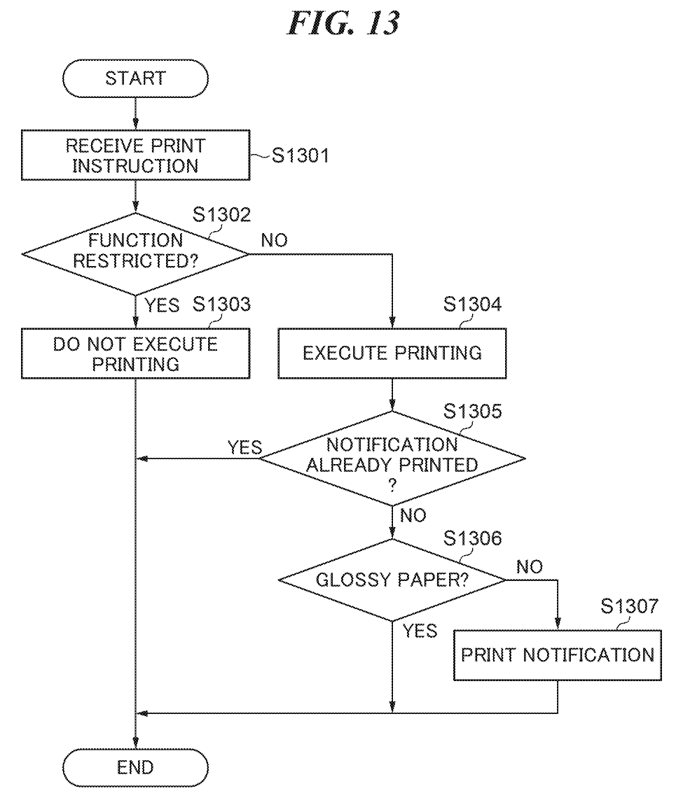

FIG. 13 is a flowchart of a third variation of the printing control process performed by the image processing apparatus 100 shown in FIG. 1. Note that the printing control process in FIG. 13 is a process similar to the above-described printing control process in FIG. 9, and the following description will be given mainly of different points from the above-described printing control process in FIG. 9. Similar to the above-described printing control process in FIG. 9, the printing control process in FIG. 13 is realized by the CPU 101 of the image processing apparatus 100, executing a program stored e.g. in the ROM 102. Note that similar to the above-described printing control process in FIG. 9, it is assumed that the above-described reception control process is executed to set or release function restriction in the image processing apparatus 100 before execution of the printing control process in FIG. 13.

Referring to FIG. 13, first, similarly to the above-described step S901, the CPU 101 receives a print instruction provided by the user (S1301). Then, similarly to the above-described step S902, the CPU 101 determines whether or not function restriction has been set (S1302).

If it is determined in the step S1302 that function restriction has been set, similarly to the above-described step S903, the CPU 101 does not execute printing according to the received print instruction, (S1303). After that, the present process is terminated.

If it is determined in the step S1302 that function restriction has not been set, the CPU 101 executes printing according to the received print instruction (S1304). Then, the CPU 101 determines whether or not the notification for notifying occurrence of the payment trouble has already been printed (S1305). If it is determined that this notification has already been printed, the present process is terminated. If it is determined that this notification has not been printed yet, the present process proceeds to a step S1306.

In the step S1306, the CPU 101 determines whether or not the printing sheet is glossy paper more expensive than plain paper. In the step S1306, for example, in a case where the printing sheet set by the user when the print instruction has been provided is glossy paper, it is determined that the printing sheet is the glossy paper. In this case, the CPU 101 terminates the present process without printing this notification. On the other hand, in a case where the printing sheet set by the user when the print instruction has been provided is a type of sheet other than glossy paper, it is determined that the printing sheet is not the glossy paper. In this case, the CPU 101 prints this notification (S1307). As a result, for example, the above-mentioned print product 1201 is output. After that, the present process is terminated.

According to the present embodiment, the print product 1201 is output in a case where the printing sheet set by the user is a sheet other than the glossy paper more expensive than the plain paper but is not output in a case where the printing sheet is set to the glossy paper. With this, it is possible to prevent the notification for notifying occurrence of the payment trouble from being printed on an expensive sheet, and this makes it possible to reduce the economic burden on the user.

Although the embodiment and the variations thereof have been described above in detail, the present disclosure can take the form of an embodiment, such as a system, an apparatus, a method, a program, or a recording medium (storage medium). Specifically, the present disclosure can be applied to a system formed by a plurality of apparatuses (such as a host computer, an interface device, an image capturing apparatus, and a web application) or applied to an apparatus formed by a single apparatus.

According to the present disclosure, it is possible to cause a user to recognize occurrence of a payment trouble.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-206281, filed Nov. 27, 2024, which is hereby incorporated by reference herein in its entirety.

What is claimed is:

1. An information processing apparatus that can be used at a flat rate during a contract period, comprising:
a communication unit configured to perform communication with a management apparatus that manages a contract state of the information processing apparatus; and
a control unit configured to perform control to restrict functions which are available in the information processing apparatus, based on control information received from the management apparatus,
wherein in a case where it is determined, based on the control information, that a payment trouble has occurred in payment for the contract of the information processing apparatus, the control unit performs control to notify occurrence of the payment trouble.

2. The information processing apparatus according to claim 1, wherein the control information includes information indicating that the payment trouble has occurred and information indicating whether or not to restrict the functions which are available in the information processing apparatus.

3. The information processing apparatus according to claim 2, wherein the control information transmitted from the management apparatus when it is determined by the management apparatus that a predetermined time period has not elapsed from the time of occurrence of the payment trouble includes the information indicating that the payment trouble has occurred and information indicating that the functions which are available in the information processing apparatus are not restricted, and
wherein the control information transmitted from the management apparatus when it is determined by the management apparatus that a predetermined time period has elapsed from the time of occurrence of the payment trouble includes the information indicating that the payment trouble has occurred and information indicating that the functions which are available in the information processing apparatus are restricted.

4. The information processing apparatus according to claim 1, further comprising a display unit, and
wherein in a case where it is determined, based on the control information, that a payment trouble has occurred in payment for the contract of the information processing apparatus, the control unit controls the display unit to display a notification for notifying occurrence of the payment trouble.

5. The information processing apparatus according to claim 1, further comprising a printing unit, and
wherein in a case where it is determined, based on the control information, that a payment trouble has occurred in payment for the contract of the information processing apparatus, the control unit controls the printing unit to output a print product notifying occurrence of the payment trouble.

6. The information processing apparatus according to claim 5, wherein the control unit controls the printing unit to output the print product notifying occurrence of the payment trouble in a case where the printing sheet set by the user is not a predetermined type of paper, which is more expensive than plain paper, and controls the printing unit not to output the print product notifying occurrence of the payment trouble in a case where the printing sheet set by the user is the predetermined type of paper.

7. The information processing apparatus according to claim 6, wherein the predetermined type of paper is glossy paper.

8. A method of controlling an information processing apparatus that can be used at a flat rate during a contract period, comprising:
performing communication with a management apparatus that manages a contract state of the information processing apparatus;
performing control to restrict functions which are available in the information processing apparatus, based on control information received from the management apparatus, and
wherein in a case where it is determined, based on the control information, that a payment trouble has occurred in payment for the contract of the information processing apparatus, the control includes control to notify occurrence of the payment trouble.

9. A non-transitory computer-readable storage medium storing a program for causing a computer to execute a method of controlling an information processing apparatus that can be used at a flat rate during a contract period,
wherein the method comprises:
performing communication with a management apparatus that manages a contract state of the information processing apparatus;
performing control to restrict functions which are available in the information processing apparatus, based on control information received from the management apparatus, and
wherein in a case where it is determined, based on the control information, that a payment trouble has occurred in payment for the contract of the information processing apparatus, the control includes control to notify occurrence of the payment trouble.
